(19) United States
(12) Patent Application Publication
(10) Pub. No.: US 2014/0048662 A1
(43) Pub. Date: Feb. 20, 2014

(54) ARTICLE SUPPORTING SUCH AS SUSPENDED OR SECURED TO A FOLDABLE AIRLINE SEATBACK TRAY AND INCLUDING LATERALLY ADJUSTABLE CORNER FRAMES FOR SUPPORTING A COMPUTER TABLET OR SMARTPHONE

(71) Applicant: Robin C. Ferris, Waterford, MI (US)

(72) Inventor: Robin C. Ferris, Waterford, MI (US)

(21) Appl. No.: 13/859,565

(22) Filed: Apr. 9, 2013

Related U.S. Application Data
(60) Provisional application No. 61/684,480, filed on Aug. 17, 2012.

(51) Int. Cl. F16M 13/02

(52) U.S. Cl. CPC F16M 13/02
USPC 248/205.1

(57) ABSTRACT

A device secured to an elevated location and in turn supporting an item such as a computer tablet. A hinged and foldable body has first and second pivotal sections each depicting a “U” shaped cross sectional profile and convertible between a collapsed/storage configuration and an extended/use configuration in which the sections establish a continuous and three sided support surface. A pair of suspending hooks extend upwardly from spaced apart locations along the body for engaging a vertical extending (seatback tray) support edge. Depth adjustable abutment portions located beneath the hooks establish proper angular orientation in use. Laterally adjustable and vertically extending brackets support vertical edges of the item placed upon the support surface.

### CROSS-REFERENCE TO RELATED APPLICATIONS

This Application claims the benefit of U.S. Provisional Application 61/684,480 filed on Aug. 17, 2012, the contents of which are incorporated herein in its entirety.

### FIELD OF THE INVENTION

A device capable of being secured or suspended from an elevated location not limited to a foldable airline seatback tray. The device exhibits a hinged and foldable body having first and second pivotal sections each depicting a “U” shaped and trough defining cross sectional profile and convertible between a collapsed/storage configuration and an extended/use configuration in which the sections establish a continuous and three sided support surface.

A pair of suspending hooks extend upwardly from spaced apart locations along the body, typically proximate opposite edges, and which are adapted for engaging a vertical extending support edge such as a seatback located tray in an upright pivoted position. Additional and depth adjustable abutment portions are located beneath engaging locations of the hooks and function to establish a proper angular orientation to the device when in use. Each of the sections further includes a laterally displaceably supported and vertically extending bracket, these adjustable for supporting vertical edges of an item placed upon the support surface such as including but not limited to a book or a rectangular shaped computer tablet.

### BACKGROUND OF THE INVENTION

Hands-free supporting devices, such as for use with normally hand-held objects are known in the art. A first example of this is set forth in U.S. Pat. No. 7,861,985, to Galvin, which teaches an electronic device holder having a flexible adjustable gooseneck, the proximal end of which carries a tab having two spring pins that securely engage with a pocket member. A securing/attachment means secures the pocket member to the backside of the handheld electronic device. A distal end of the flexible gooseneck connects to a spring clip similar to a clothes line pin, which attaches the hands-free electronic device holder to an airline dining tray or a worktable.

U.S. Pat. No. 7,740,312, to Johnson, Jr. teaches a collapsible/storable drink holder assembly mountable above an airline table tray, such as a sufficient distance to accommodate a laptop computer seated upon the tray, and including a support extending downwardly from the drink holder. A mounting mechanism connected to the support removably mounts the drink holder on the tray.

Other references of note include Graham, US 2007/0164987 which teaches a hands-free support apparatus configured so as to be mounted to the human anatomy. Chivallier, U.S. Pat. No. 5,988,572, teaches a cradle device for a portable radio terminal also supported in gooseneck adjustable fashion to a flat surface.

### SUMMARY OF THE INVENTION

As previously described, the present invention discloses a device capable of being secured or suspended from an elevated location not limited to a foldable airline seatback tray and for supporting any rectangular and three dimensional object such as not limited to an electronic computer tablet or the like. In one non-limiting variant, the device exhibits a hinged and foldable body which are made up of first and second pivotal sections, each depicting a “U” shaped cross sectional profile and which are convertible between a collapsed/storage configuration and an extended/use configuration in which the sections establish a continuous and three sided support surface.

A pair of suspending hooks extend upwardly from spaced apart locations along the body, typically proximate opposite edges, and which are adapted for engaging a vertical extending support edge such as a seatback located tray in an upright pivoted position. In one application, the hooks each include a pivotal and elongated support member secured to rear edge locations of each section and which exhibit a support surface terminating at an upper end in an inward extending engagement portion having a reverse angled clip end. The engagement portions can further be pivotally associated in a spring loaded fashion and, in combination with additional and depth adjustable abutment portions located beneath the engagement portions, function to establish a proper angular orientation to the device when in use.

Each of the sections further includes a laterally displaceably supported and vertically extending bracket, these adjustable for supporting vertical side edges of an item placed upon the support surface such as including but not limited to a book or a rectangular shaped computer tablet. Lateral extending portions associated with the displaceable brackets can be secured to forward inner edges of each of the pivotally interconnecting sections and exhibit length extending slots which seat pins or rivets in order to establish a range of width adjustability. Interconnecting vertical portions of each displaceable bracket secure to remote ends of the lateral extending portions in order to provide stable and width adjustable support to the side edges of the supported tablet or the like.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the article supporting device according to one non-limiting embodiment exhibited in a use position;

FIG. 2 is a side view of the device shown in FIG. 1 with the side edge supporting and displaceable brackets removed for clarity of depiction and in order to illustrate a computer table in a supported position;

FIG. 3 is a front view of the article supporting device of FIG. 1;

FIG. 4 is a top view;

FIG. 5 is a bottom view and FIG. 6 a succeeding underside perspective further depicting, among other things, a displaceable clip for engaging over a split boundary surface established between the pivotally aligned sections in a use position;

FIG. 7 is a cutaway taken along line 7-7 of FIG. 3 and FIG. 8 is a likewise cutaway taken along line 8-8 of FIG. 3, each depicting an extending edge profile of a side edge located and displaceable bracket including upper engaging portion and depth adjustable abutment portion;

FIGS. 9A-9B illustrate the displaceable clip of FIGS. 5-6 in both engaged and release positions to permit closed folding of the individual body sections;

FIG. 10 is an illustration similar to FIG. 1 of the article supporting device with the side extending portions initially displaced to innermost positions relative to the pivotally supported body sections;

FIG. 11 is a succeeding illustration of the vertical portions rotated into collapsed and recessed position relative to the lateral seating portions for each side edge supporting bracket;

FIG. 12 is a further succeeding illustration of the hook engaging portions rotatably collapsed against their vertical extending supports, concurrent with the hinged abutment portions being flattened against the vertical supports;

FIGS. 13-14 are succeeding illustrations of the hooks being folded into their respective body sections;

FIG. 15 is a fully collapsed and storage illustration in which the body sections are folded closed against each other and in order to obscure the inner folded side edge supports and hooks; and

FIG. 16 an exploded perspective of all of the components of the article support device.

### DETAILED DESCRIPTION OF THE PREFERRED EMBODIMENTS

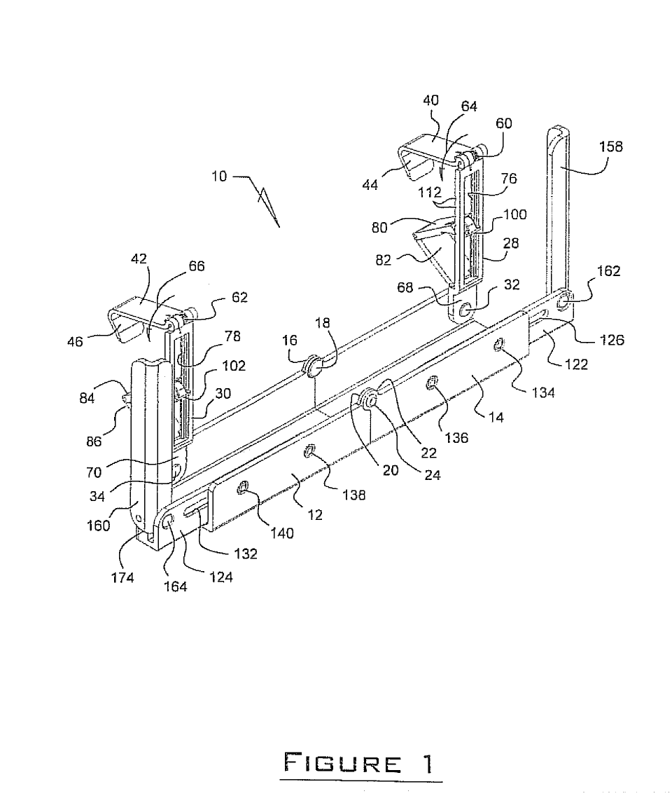

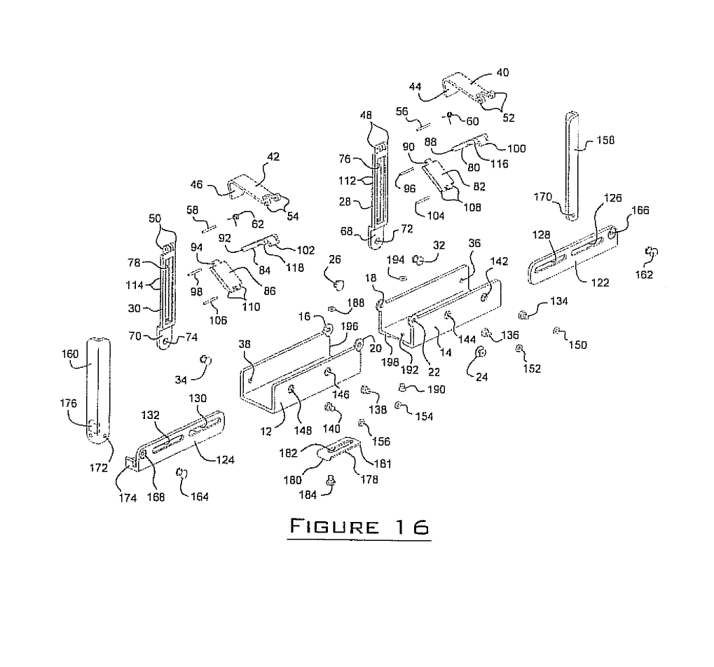

As previously described, the present invention discloses a device capable of being secured or suspended from an elevated location not limited to a foldable airline seatback tray for providing hands free support of any object such as a rectangular shaped computer tablet device. As depicted throughout the drawings, beginning with the perspective assembled view of FIG. 1 and ending in the exploded view of FIG. 16, the device, generally shown at 10, can exhibit a hinged and foldable body which are made up of first 12 and second 14, each depicting a “U” shaped cross sectional profile.

A pivotal connection is established at hinged locations established between the sections 12 and 14 and which are in alignment with upper joining edges thereof. In the variant illustrated, the hinged locations are established by overlapping pairs of lobes 16 & 18 and 20 & 22 projecting upwardly from adjoining inner edge locations of the sections 12 and 14 in an overlapping and pivotally allowed fashion. As further shown, a rivet (at 24 associated with overlapping lobes 20 and 22 and further at 26 associated with overlapping lobes 16 and 18) can be passed through likewise aligning apertures (see FIG. 16) associated with each pair of overlapping lobes, this providing ease of fold-ability.

The hinged connection facilitates converting the device between a fully open and use position (FIG. 1) and a fully collapsed and stored position (FIG. 15). As shown, the hinged locations 16 and 18 are arranged at upper edge locations of the spaced apart sidewalls of the sections 12 and 14 and so that the individual “U” shaped and trough defining sections 12 and 14 can be converted to the use position by rotating the opposing and inner pivoting “U” shaped edges of each section into abutting engagement as shown in FIG. 1. Without limitation, the present inventions also contemplate additional fixed variants which are not foldable.

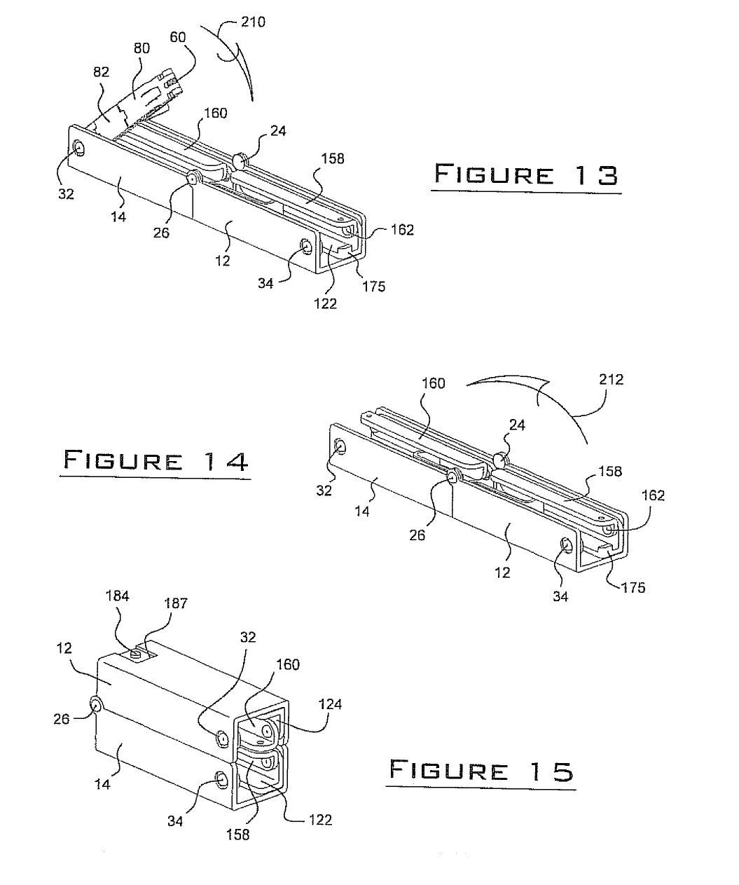

A pair of suspending hook subassemblies are provided and which extend upwardly from spaced apart locations along the body, typically proximate opposite edges, and which are adapted for engaging a vertical extending support edge (not shown) such as a seatback located tray in an upright pivoted position. In the illustrated variant, the hook subassemblies each include a first elongated support member, at 28 and 30, which is pivotally mounted (such as by rivets 32 and 34) to rear and outer edge proximate locations (see further apertures 36 and 38 in FIG. 16) of each pivotal section 12 and 14. In this manner, the elongated members 28 and 30 can be pivoted between upright (FIG. 1) and internally folded (FIGS. 13-15) positions.

The pivotal supported and elongated support members 28 and 30 each terminate at an upper end in an inward extending engagement portion, at 40 and 42, each of which having a reverse angled clip end 44 and 46. The upper engagement portions 40 and 42 can further be pivotally associated in a spring loaded fashion with the support members 28 and 30 and, as best shown in FIG. 16, this is facilitated by overlapping pairs of ears or tabs established at upper end locations of the support members 28 and 30 (in particular shown by pairs of ears 48 and 50, respectively).

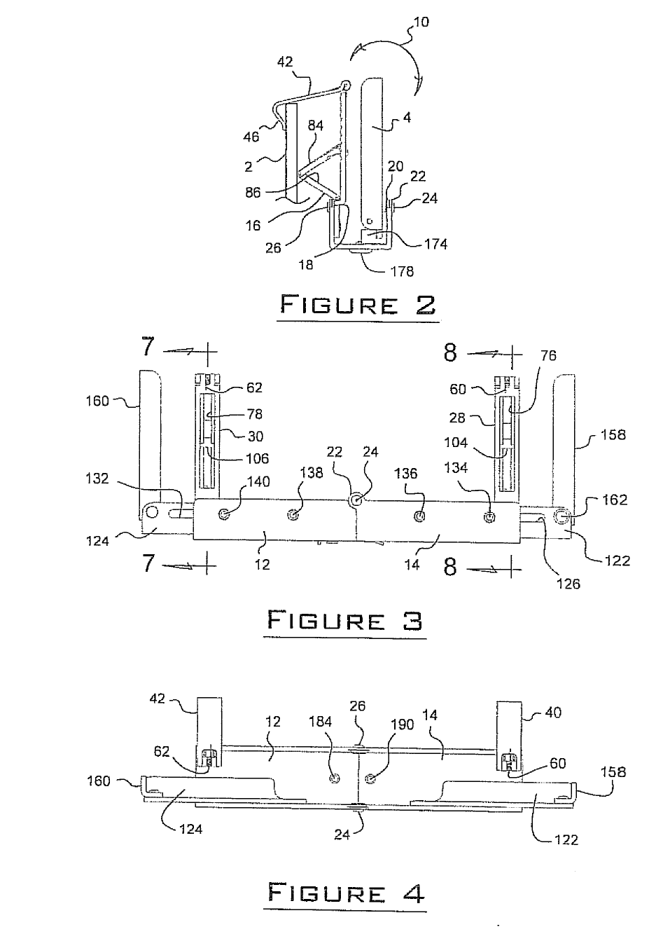

Additional pairs of ears 52 and 54 are provided in association with rear interconnecting edges of the engagement portions 40 and 42 and, when aligned with the additional and offset pairs of ears 48 and 50) receive pins 56 and 58 for pivotally supporting the engagement portions to the support members. Also provided are biasing springs 60 and 62 which are supported upon the pin 56 and 58 and in order to bias each engagement portion 40 and 42 in a downward direction as generally reflected by arrows 64 and 66 in FIG. 1. In this fashion, and upon the reverse angled clip ends 44 and 46 engaging the upper extending edge of the elevated support location (i.e. a generally vertically and upwardly retracted seat back tray table in upright position as depicted generally at 2 in FIG. 2), while the springs 60 and 62 further bias the engagement portions 40 and 42 in a responsive and opposing fashion (as again reflected by arrows 64 and 66) to the bending forces exerted by the tray table.

The elongated support members 28 and 30 each further include a lower most portion 68 and 70 incorporating an aperture (see at 72 and 74 in FIG. 16) for receiving the pivotally enabling rivets 32 and 34 in aligning engagement with the mounting locations 36 and 38 on the rear face of the individual sections 12 and 14. The configuration of the elongated support members 28 and 30 are each further such that each is configured to include a linearly extending interior window extending substantially along its length (see as best shown in FIG. 16 at 76 and 78 for elongated support members 28 and 30, respectively).

A depth adjustable abutment portion is provided in the form of first and second pairs of pivotally interconnected and inter-adjustable flaps, see at 80 & 82 and 84 & 86, each pair being configured for installation to each of the elongated support members 28 and 30 at locations beneath the engagement portions 40 and 42. As best shown in FIG. 16, the flaps each exhibit aligning and overlapping sleeve locations (see at 88 and 90 for flaps 80 & 82 as well as at 92 and 94 for flaps 84 & 86), with selected pins 96 and 98 pivotally interconnecting the pairs of flaps in the manner shown.

The configuration of the flaps is further such that they are supported within the rectangular shaped inner windows 76 and 78 of the elongated support members 28 and 30 in a manner in which they are adjustable between the tented and substantially “V” shaped profile depicted in FIG. 1 and the fully extended and flattened profile of FIGS. 11-12. To this end, the upper flaps 80 and 84 each exhibit an integrally formed end projection, at 100 and 102 respectively, which is configured and dimensioned to seat within opposing recessed inner walls associated with the inner frame of each interior window 76 and 78.

Additional pins 104 and 106 are provided and which seat through additional sleeve locations 108 and 110 associated with the pivotally interconnecting flaps 82 and 86, the pins 104 and 106 being seated within bottom most locations of the inner frames for each window 76 and 78 (see FIG. 1). As shown, an exterior defined track surface is exhibited for each of the elongated support members in proximity to the interior defined frames, each of the track surfaces being exhibited by a ribbed or uneven profile (see at 112 and 114 for support members 28 and 30) and which is configured to abut an opposite facing and lateral edge profile (further at 116 and 118 in FIG. 16) of each flap 80 and 84, such as at stepped locations along the intermediate height of the elongated support members 28 and 30, and so that the pairs of flaps 80 & 82 and 84 & 86 can be reliably and quickly readjusted to differing angular orientations between the fully rearward extended position of FIG. 1 and the flattened/recessed position of FIGS. 11-12 (such as preceding folding storage of the device).

The flaps operate in order to establish a proper angular orientation to the device when in use and so that, upon the engagement portions 40 and 42 contacting the upper edge of a thin, planar surfaced and generally vertically extending support exhibiting an upper horizontal edge (see seat back pivotally mounted tray table 2 generally depicted in FIG. 2 to correspond to an upright rotated position), the reverse angled clip ends 46 and 48 abut against a first surface of the support 2, whilst the pivotal ends of the pairs of flaps 80/82 and 84/86 abut an opposite surface in order to provide a desired angular orientation to the body sections 12 and 14 for viewing the electronic tablet 4 or other suitable object supported upon the device. As facilitated by the above description, the flaps can further be easily inter-adjusted to permit the device and the supported tablet 4 to be orientated as desired about a generally horizontal axis (see arrow 120 in FIG. 2), such as for optimal viewing by the individual seated behind the device.

Each of the sections 12 and 14 further includes a laterally displaceably supported and vertically extending bracket subassemblies, each of which are adjustable for supporting vertical side edges of the object or item (such as again at 4 in FIG. 2) placed upon the support surface and such as including but not limited to a book or a rectangular shaped computer tablet. Lateral extending portions, these in the form of elongated plates, are shown at 122 and 124 associated with the displaceable brackets and can be secured to forward inner edges of each of the pivotally interconnecting sections 12 and 14.

Each of the elongated plates exhibit length extending slots (see extending pairs of elongated and interior extending perimeter edges including at 126/128 for plate 122 and 130/132 for plate 124), which seat pins or rivets, further shown in pairs 134/136 and 138/140 through aperture locations 142 & 144 (section 12) and 146 & 148 (section 14) in the front faces thereof Portions of each of the rivets 134/136 and 138/140 which extend through the aperture locations 142/144 and 146/148 receive washer shaped engaging rings 150/152 and 154/156, this in order to secure the laterally displaceable and elongated plates 122 and 124 in place and in order to establish a range of width adjustability. The arrangement of the elongated slots 126/128 and 130/132 in length separated and linear fashion, in combination with the arrangement of the rivets 134/136 and 138/140, prevents pivoting or bowing of the plates 122 and 124 during laterally displaceable and readjusting motion.

Each of the side displaceable brackets further includes an interconnecting vertical portion, see additional bars 158 and 160 (each of which exhibiting a generally “L” shape in profile. The bars 158 and 160 are further configured such that they secure to remote ends of the lateral extending plates 122 and 124, such as via additional rivets 162 and 164 which pass through additional edge apertures 166 and 168 defined in the plates 122 and 124 and seat within bottom proximate apertures 170 and 172 of each bar 158 and 160, this in order to provide stable and width adjustable support to the side edges of the supported tablet 4 or the like.

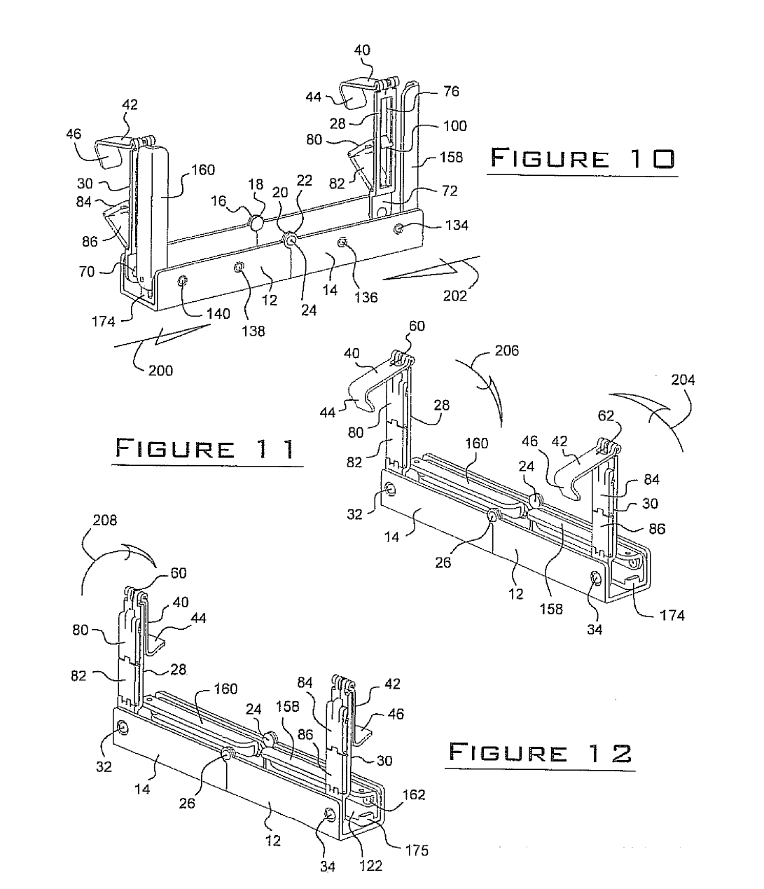

As further best shown in FIG. 16, the outer edges of each of the bottom laterally displaceable plates (such as shown by selected plate 124) further exhibits a vertical end projection 174 (see also concurrent projection 175 for first plate 122 in rotated end view of FIG. 12) which engages an aligning underside facing and depth extending recess (further shown in phantom at 176 in FIG. 16 for selected vertical bar 160). Upon pivotally rotating the bars 158 and 160 from recessed and flat positions (see again FIG. 11) to upright extending positions (FIG. 10) an end projection (again at 174) associated with each lateral extending plate 122 and 124 seats within an underside and depth extending recess (again at 176) of each hingedly interconnecting and “L” shaped bar 158 and 160 such as in order to establish an end-stop to prevent the bars from being rotated beyond a perpendicular arrangement established with the lateral plates 122 and 124 and, upon being adjusted by the user, to maintain the bars in an upright position and in supporting contact with the opposite and lateral edges of the tablet 4 or like device.

As further best shown by viewing the underside perspective of FIG. 6, in combination with FIGS. 9A-9B and the exploded view of FIG. 16, a displaceable clip is provided and which includes a generally flattened and elongated, rectangular shaped body 178 configured for engaging over the split boundary surface established between the pivotally aligned sections 12 and 14 in a use position. The body 178, as best shown in FIG. 16, exhibits a pair of outwardly curled opposite tongue edges 180 and 181 (designed for facilitating gripping by the user when applied to the underside of the selected section 12 to which the clip body 178 is mounted and in order to displace the clip as needed between engaged and released positions).

As best shown in FIG. 16, the clip also exhibits an interior and lengthwise extending inner slot 182 which receives a rivet 184. An aperture is provided in the bottom of the section 12 proximate its inner boundary defining edge (see at 186 in FIG. 9A) and, upon passing the rivet 184 through the bottom of the section 12, a further engaging washer or ring 188 (FIG. 16) engages thereto.

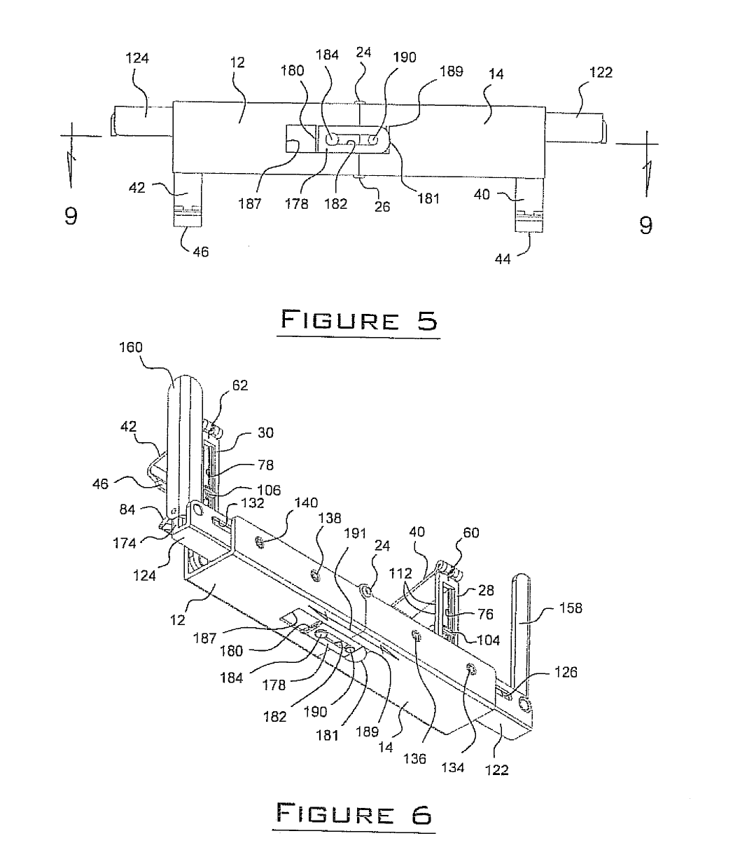

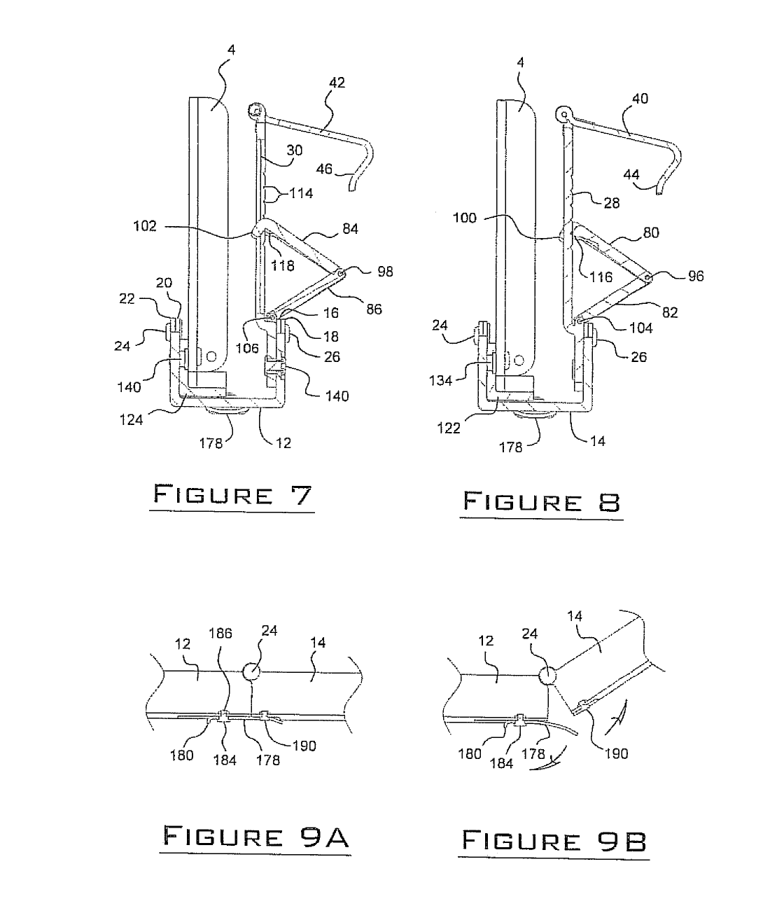

FIGS. 9A-9B illustrate the displaceable clip of FIGS. 5-6 in both engaged and release positions. Reference is also made to recessed slot end surfaces 187 and 189 in FIG. 5 which facilitate sliding of the clip body 187 bi-directionally along designated arrow 191 (further shown in FIG. 6) defined in the underside of sections 12 and 14 at their internal joining boundary. In this manner, the clip 178 provides non-pivoting securing of the individual body sections 12 and 14 in the use position of FIG. 1.

As further shown in FIG. 16, a further rivet 190 engages to an underside an inner boundary defining edge of the second section 14 (see aperture 192 in FIG. 16 which receives the underside engaging rivet 190 which further receives an engaging ring or washer 194 which can be collapsible or otherwise crimped along with the similar components previously described in order to secure the associated rivets in place). Upon sliding the clip body 178 (by virtue of the enlarged rivet head 184 being permanently seated in the slot 182) to the position of FIGS. 5 and 6, the clip body 178 is manipulated to seating engage the underside projecting rivet 190 into the slot 182 and thereby to lock the pivotal sections 12 and 14 in the use position.

In this fashion, the clip 178 can be displaced or otherwise manipulated, relative to its anchored position to the section 12 underside, and in order to engage the rivet 190 anchored to the section 14 underside proximate the inner boundary locations (these further best shown by inner aligning and “U” shaped edges 196 and 198 for sections 12 and 14 in FIG. 16). Disengagement of the clip 178 from the underside of the second inter-pivotal section 14 (by removing the underside projecting head of rivet 190 from within the slot 182) further enables rapid foldup and storage of the device 10, as further best illustrates in succeeding illustrations of FIG. 10 et seq. and which, as initially depicted in FIG. 10, includes the laterally extending plates 122 and 124 initially being displaced to innermost positions (see arrows 200 and 202) relative to the pivotally supported body sections 12 and 14.

Following this, and as depicted in FIG. 11, the vertical “L” shaped bars 158 and 160 are rotated into collapsed and recessed position (arrows 204 and 206) relative to the lateral seating portions (again at 174 for selected bar 124) for each side edge supporting bracket assembly.

FIG. 12 is a further succeeding illustration of the hook engaging portions 40 and 42 rotatably collapsed (by example at 208) against their vertical extending supports 28 and 30 (this by rotating in a direction opposite the exerted bias of the integrated springs 60 and 62), concurrent with the hinged abutment portions (pairs of flaps 80/82 and 84/86 being repositioned in a flattened or drawn out extending fashion against the vertical supports 28 and 30. FIG. 13 is a succeeding illustration of the hooks being folded (at 210) into their respective body sections 12 and 14, with the sections 12 and 14 being collapsed together (at 212 in FIG. 14) such that FIG. 15 exhibits a fully collapsed and storage illustration in which the body sections are folded closed against each other in a manner which obscures the inner folded side edge supports and hooks.

Having described my invention, other and additional preferred embodiments will become apparent to those skilled in the art to which it pertains and without deviating from the scope of the appended claims. This includes constructing the various components of any desired material not limited to a lightweight metal or a durable heavy duty plastic. Magnets (not shown) can be integrated into the design so as to maintain the device in a straightened/linear configuration when unfolded. It is also envisioned that the hooks or laterally displaceable brackets can be redesigned in ways additional and beyond that depicted in the present illustrations.

I claim:

1. An object supporting device capable of being suspended from a thin, planar surfaced and generally vertically extending support exhibiting an upper horizontal edge, said device comprising:
a body including at least one elongated section exhibiting a three dimensional cross sectional profile and which defines a trough receiving interior;
a pair of hook subassemblies extending upwardly from spaced apart locations along said body and which are adapted to engage the upper horizontal edge of the vertical support at spaced apart locations; and
a pair of laterally displaceable brackets subassemblies, each including an elongated plate secured in laterally displaceable and adjustable fashion relative to opposite ends of said body, an elongated bar extending perpendicularly from an extending end of each of said plates;
a supported object exhibiting a generally rectangular profile and adapted to being supported upon said trough receiving interior of said body, as well as optionally by said elongated bars along opposite side edges thereof of the object.

2. The device as described in claim 1, said body further comprising first and second hingedly interconnected sections, each depicting a “U” shaped cross sectional profile.

3. The device as described in claim 2, further comprising overlapping pairs of lobes projecting upwardly from adjoining inner edge locations of each of said sections in an overlapping and pivotally allowed fashion, a pair of rivets seating through aligning apertures associated with each pair of overlapping lobes.

4. The device as described in claim 2, said hook subassemblies each further comprising a first elongated support member pivotally mounted to rear and outer edge proximate locations of each interconnected section between upright and internally folded positions, said elongated support members terminating at upper ends in an inward extending engagement portions, each exhibiting a reverse angled clip end for contacting the vertical support proximate the upper horizontal edge.

5. The device as described in claim 4, further comprising said engagement portions being pivotally secured to said elongated support members by overlapping and aligning pairs of tabs established at upper end locations of said support members and along rear interconnecting edges of said engagement portions for receiving pins.

6. The device as described in claim 5, further comprising biasing springs supported upon said pins and in order to bias each of said engagement portions in a downward direction relative said elongated support members.

7. The device as described in claim 4, said elongated support members further comprising a linearly and interiorly extending window substantially along its length which are configured for seating and supporting in depth adjustable fashion a pair of rear extending abutment portions.

8. The device as described in claim 7, said abutment portions each further comprising:
a pair of pivotally interconnected and inter-adjustable flaps and which are configured for installation within a recessed sides of an inner frame associated with each of said windows; and
said pairs of flaps each exhibiting aligning and overlapping sleeve locations with additional pins pivotally interconnecting each of said pairs of flaps both to each other and in lengthwise adjustable fashion along each of said elongated support member windows in a manner in which they are adjustable between a tented and substantially “V” shaped profile and an extended and flattened profile.

9. The device as described in claim 8, upper flaps associated with each interconnected pair of flaps further comprising an integrally formed end projection configured and dimensioned to seat within opposing recessed inner walls associated with said inner defining frame of each interior window.

10. The device as described in claim 9, further comprising additional pins seating through additional sleeve locations associated with lower pivotally interconnecting flaps associated with each pair of flaps, said additional pins being seated within bottom most locations of the inner defining frames.

11. The device as described in claim 9, further comprising an exterior defined track surface exhibited for each of said elongated support members and which is exhibited by a ribbed and uneven profile configured to abut an opposite facing and lateral edge profile of each of said upper flaps, such as at stepped locations along the intermediate height of said elongated support members, enabling said pairs of flaps to be reliably and quickly readjusted to differing angular and depth extending orientations.

12. The device as described in claim 2, said elongated plates associated with said bracket subassemblies each further comprising length extending slots formed therealong, rivets engaging front faces of each of said hingedly connected sections and seating within said slots to establish a range of width adjustability of said plates.

13. The device as described in claim 12, each of said elongated bars further comprising a generally “L” shape in profile, said bars pivotally securing to remote ends of each of said laterally extending plates via additional rivets which pass through additional edge apertures defined in said plates and seat within bottom proximate apertures of each bar.

14. The device as described in claim 13, further comprising outer edges of each of said laterally displaceable plates having a vertical end projection which engages an aligning underside facing and depth extending recess of each pivotally connected bar and in order to establish an end-stop to prevent said bars from being rotated beyond a perpendicular arrangement established with the said plates.

15. The device as described in claim 2, further comprising a displaceable engagement clip having a generally flattened and elongated shape and which is configured for engaging over an underside facing and split boundary surface established between said hinged and pivotally aligned sections in an extended and use position.

16. The device as described in claim 15, said clip further comprising an inner slot and being secured to a first of said hinged sections via a first underside mounted rivet, said clip extending across the split boundary surface and so that a second underside rivet mounted to said second hinged section is engageable within said inner slot.

17. The device as described in claim 16, said clip further comprising at least one configured tongue edge for facilitating grasping and displacing thereof.

18. An object supporting device capable of being suspended from a thin, planar surfaced and generally vertically extending support exhibiting an upper horizontal edge, said device comprising:
a body including first and second hingedly interconnected sections, each depicting a “U” shaped cross sectional profile and which defines a trough receiving interior;
a displaceable engagement clip having a generally flattened and elongated shape and which is configured for engaging over an underside facing and split boundary surface established between said hinged and pivotally aligned sections in an extended and use position;
a pair of hook subassemblies extending upwardly from spaced apart locations along said body and which are adapted to engage the upper horizontal edge of the vertical support at spaced apart locations;
a pair of laterally displaceable brackets subassemblies, each including an elongated plate secured in laterally displaceable and adjustable fashion relative to opposite ends of said body, an elongated bar extending perpendicularly from an extending end of each of said plates; and
said elongated plates associated with said bracket subassemblies each further comprising length extending slots formed therealong, rivets engaging front faces of each of said hingedly connected sections and seating within said slots to establish a range of width adjustability of said plates;
a supported object exhibiting a generally rectangular profile and adapted to being supported upon said trough receiving interior of said body, as well as optionally by said elongated bars along opposite side edges thereof of the object.

19. An object supporting device capable of being suspended from a thin, planar surfaced and generally vertically extending support exhibiting an upper horizontal edge, said device comprising:
a body including at least one elongated section exhibiting a three dimensional cross sectional profile and which defines a trough receiving interior;
a pair of hook subassemblies extending upwardly from spaced apart locations along said body and which are adapted to engage the upper horizontal edge of the vertical support at spaced apart locations;
said hook subassemblies each further comprising a first elongated support member pivotally mounted to rear and outer edge proximate locations of each interconnected section between upright and internally folded positions, said elongated support members terminating at upper ends in an inward extending engagement portions, each exhibiting a reverse angled clip end for contacting the vertical support proximate the upper horizontal edge;
said elongated support members further comprising a linearly and interiorly extending window substantially along its length which are configured for seating and supporting in depth adjustable fashion a pair of rear extending abutment portions;
said abutment portions each further comprising a pair of pivotally interconnected and inter-adjustable flaps and which are configured for installation within a recessed sides of an inner frame associated with each of said windows and in lengthwise adjustable fashion along each of said elongated support member between a tented and substantially “V” shaped profile and an extended and flattened profile; and
a pair of laterally displaceable brackets subassemblies, each including an elongated plate secured in laterally displaceable and adjustable fashion relative to opposite ends of said body, an elongated bar extending perpendicularly from an extending end of each of said plates;
a supported object exhibiting a generally rectangular profile and adapted to being supported upon said trough receiving interior of said body, as well as optionally by said elongated bars along opposite side edges thereof of the object.
